(19) United States
(12) Patent Application Publication
(10) Pub. No.: US 2012/0218782 A1
(43) Pub. Date: Aug. 30, 2012

(54) METHOD AND APPARATUS FOR SIGNAL CONVERSION

(76) Inventors: Richard Bodkin, Tucson, AZ (US); Richard Lukso, Tucson, AZ (US)

(21) Appl. No.: 13/392,840

(22) PCT Filed: Jul. 29, 2010
(86) PCT No.: PCT/IB10/53442

§ 371 Date: Feb. 27, 2012

Related U.S. Application Data
(60) Provisional application No. 61/234,979, filed on Aug. 18, 2009.

(51) Int. Cl. H02M 7/02

(52) U.S. Cl. 363/13

(57) ABSTRACT

To convert an electrical signal from one form to another form a chopper element is placed in a circuit for receiving any arbitrary input signal. The chopper element generates a second signal. A transformer element receives the second signal at the primary winding and generates a third signal in the secondary winding. A rectification or reconstruction element is used to ensure that the third signal has the desired frequency, magnitude and polarity. A method for converting the signal is also disclosed.

### FIELD OF THE INVENTION

This invention is in the field of signal conversion from one voltage level to another or from direct current to alternating current or any combination thereof. More particularly this invention describes high-frequency signal conversion by chopping or switching a signal in conjunction with a variety of rectification and reconstruction means. Specifically, this invention describes a method and apparatus for signal conversion.

### BACKGROUND OF THE INVENTION

Power supplies in electronic systems are used to convert one energy signal into another energy signal. In general the goal of these power supplies is to take energy in a format that cannot be used directly by the load and converting it into a format that is useful to the load. For example, a transformer, rectifier and voltage regulator may be used to convert 60 Hertz 110 volt energy to direct current energy at 9 volts, suitable for a small portable radio.

Alternating current (AC) systems that accept and deliver alternating current are most often based on transformers or motor-generator pairs. These systems are found in grid power distribution, allowing energy to be distributed around the country at tens of thousands and sometimes hundreds of thousands of volts, but then this voltage is reduced to the more common 110 or 220 volts that is used in households. The size and weight of these transformers is generally not an issue in grid power systems, but does become a major issue in systems such as aircraft where the need to convert alternating current of one voltage to alternating current of another voltage is required, but weight and space savings is also critical.

Conversion of alternating current to direct current (DC) is often required for grid power and transportation systems where a combination of generators, batteries and electronics may be used. Conversion of AC to DC may be performed by linear power supplies which generally convert the energy using means that are not efficient. Power is delivered to the load at the desired voltage and current, usually by throwing away the unused voltage and current in the form of heat.

Switching power supplies are an improvement on linear power supplies in that they are much more efficient. They are often used in electronic systems to transfer electrical energy from one circuit to another and to step-up or step-down the voltage of electrical signals to a level that is useful for the end function. These switching systems generally convert the energy itself and therefore generate very little heat, but are considerably more complex than linear systems.

Two fundamental forms of signal, Direct Current and Alternating Current may be used to deliver energy to the power supply, and the power supply may deliver energy in a direct current or alternating current format to the load. Direct current (DC) energy is often delivered to the switching power supply from sources such as batteries, solar panels or similar devices that produce a voltage and/or current that is fairly constant and has a fixed polarity. It is possible for the direct current energy to have a highly variable wave shape. For example, if a cloud passes in front of a solar installation, the voltage output of the solar system will drop and then recover, but will not change polarity.

Alternating current (AC) energy is often delivered to the switching power supply from sources such as the electrical grid system, from turbines, generators and windmills. Some generator systems such as piezoelectric generators will produce highly irregular wave shapes. Switching power supplies that use AC energy first convert the energy to DC. These AC input power supplies suffer from power-factor correction problems because they tend to only use power from the peak of each AC wave. The proliferation of these systems has caused significant distortion of the signals on the AC grid system worldwide and has lead to highly enforced legislation with respect to power factor correction elements that must be built into new switching power supplies brought into the marketplace.

An existing problem in most power supplies is that they are limited to two distinct classes of input energy. That is the input energy must be one of Direct Current (DC) or Alternating Current (AC).

There exists a need for a power conversion system that can accept both DC or AC power. Another problem with most power supply systems is their inability to operate with varying input conditions such as direct current voltages that vary with an unexpected wave shape.

There exists a need for a power conversion system that will accept and utilize energy from any arbitrary input wave shape. A problem with AC switching power supply systems that include a DC conversion front end is their poor power factor which is normally addressed by adding additional electronics, filtering and input stages which reduces efficiency.

There exists a need for a switching power supply that can accept AC signals without power factor correction. A problem with linear AC power supplies and some switching AC power supplies is that the magnetic transformers used in them can be very heavy. There exists a need for a switching power supply system that minimizes the number and size of magnetic elements to reduce weight. A final problem with AC input switching power supplies is the loss of overall efficiency caused by the multiple conversion and filtering stages that are required to perform the conversion and meet government regulated emissions and power factor control standards.

Therefore, based on the deficiencies outlined above, there exists a need for a system capable of converting one AC voltage to another AC voltage in a way that is much lighter and preferably smaller than existing methods employing transformers. Furthermore, there exists a need for a power conversion system that has few stages and therefore higher efficiency.

### SUMMARY OF THE INVENTION

In one embodiment of the invention there is provided a system for converting an electrical signal from a first form to a second form. The system comprises: a circuit for carrying an input signal having a first polarity and a second polarity and in a first form at a first frequency and a first voltage; a chopper element disposed within the circuit for receiving the input signal and generating a second signal at a second frequency and a second voltage, wherein the second frequency is greater than the first frequency; and, a transformer element disposed within the circuit and connected to the chopper element. The transformer element includes at least a primary winding and a secondary winding. The transformer element receives the second signal at the primary winding and generates a third signal at the secondary winding. The third signal has a third voltage and a third frequency equal to the second frequency. The system further comprises a rectification element disposed within the circuit and connected to the transformer element for receiving the third signal from the secondary winding and converting it into a rectified signal in a second form and a control element connected to the rectification element for controlling the rectification element so that the rectified signal is a direct current signal at a desired magnitude. Finally there is a storage element disposed within the circuit and connected to the rectification element for receiving the direct current signal from the rectification element and storing the direct current signal.

One embodiment of the invention can accept an input signal of any arbitrary wave-shape including alternating or direct current. It includes a chopper element for alternately inverting the polarity of the input signal at a frequency that is higher than any anticipated frequency of the input signal.

In one embodiment of the invention the rectification element is a synchronous rectification and polarity correction element. In one embodiment of the invention the control element is connected between the chopper element and the rectification element so that the rectifier element signal is synchronized and maintains the desired output polarity regardless of the first polarity. The rectified signal is normally a DC signal. The polarity of the input and output may not necessarily match. The control element controls the chopper and rectification elements to ensure that the output maintains the desired polarity. The second frequency may be more than 100 times the first frequency.

In another embodiment of the invention the chopper element comprises a first set of input switches that close to direct the second signal from the top of the primary winding to the bottom of the primary winding so that the third signal is induced in the secondary winding from the top of the secondary winding to the bottom of the secondary winding. The result is that the second signal and the third signal have the same direction. The chopper element further comprises a second set of input switches that close to direct the second signal from the bottom of the primary winding to the top of the primary winding so that third signal is induced in the second winding from the bottom of the secondary winding to the top of the secondary winding. The result is that the second and the third signal have the same direction. The first set of input switches is open when the second set of input switches is closed and the first set of input switches is closed when the second set of input switches is open. There may also be periods where both sets of switches are open, allowing the magnetic flux in the transformer to bleed down, effectively allowing voltage or current regulation to take place. There should not be periods where both sets of switches are closed. The first set and second sets of switches open and close in an alternating fashion at a frequency equal to the second frequency. The order in which the first set of switches and second set of switches open and close is dependent upon input signal polarity.

### BRIEF DESCRIPTION OF THE DRAWINGS

Implementations will become more apparent from the detailed description set forth below when taken in conjunction with the drawings, in which like elements bear like reference numerals.

FIG. 1 is a block diagram of a prior art conventional switch mode AC to DC converter system.

FIG. 2 is a block diagram of one embodiment of the invention.

FIG. 3 is a diagram of the waveforms which may be present in the system of one embodiment of the invention.

FIG. 4 is a simplified schematic diagram of a circuit to implement the system of one embodiment of the invention with resulting DC output.

FIG. 5 is a simplified schematic diagram of a circuit to implement the system of one embodiment of the invention with resulting AC output.

### DETAILED DESCRIPTION

The present invention is described in preferred embodiments in the following description with reference to the Figures, in which like numbers represent the same or similar elements.

Reference throughout this specification to ‘one embodiment,’ ‘an embodiment,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment. The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Switching or chopper based power systems have been in use for many years as a method to convert one Direct Current (DC) voltage to another DC voltage. By chopping up the DC signal and feeding it into an inductor or a transformer, it is possible to store magnetic energy, then redirect that energy in a way that may increase the voltage (Step-Up or Boost) or step-down (Buck) the voltage. It is also possible to construct these systems, often referred to as ‘DC/DC converters’ so that they can increase or decrease the voltage applied. Modern power supply systems are required to convert Alternating Current (AC) into DC, or an ‘AC/DC converter’ in a way that is efficient to reduce heat. Such AC/DC systems can be found in computers, television sets and any other electronic equipment that requires DC voltages internally, but must connect to the AC power grids found around the world at voltages including 100, 110, 220 and 240 volts at frequencies of generally 50 or 60 Hertz. Systems for converting AC to AC are common in power distribution systems and are generally implemented using transformers simply by applying the alternating current energy directly to the magnetic element.

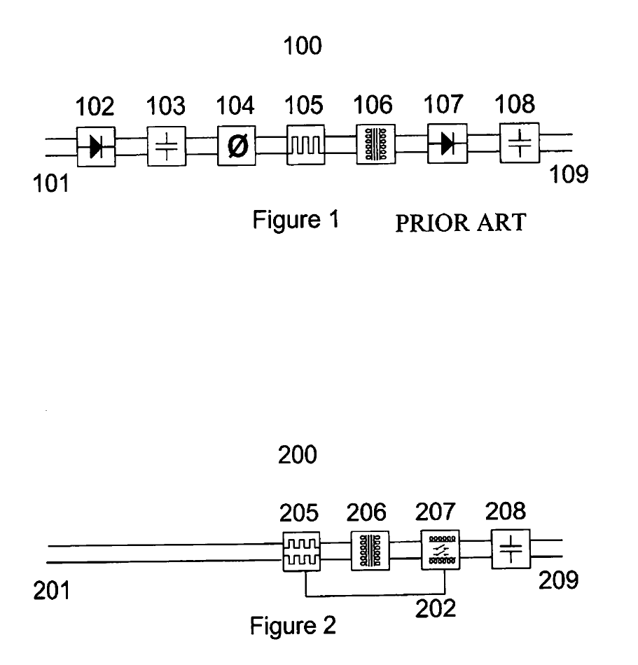

FIG. 1 shows a prior art block diagram of a modern AC/DC switching power supply (100). The AC signal is applied at the input terminals (101) and is rectified (102) into a high voltage DC signal that is stored in a capacitor (103) or other element. This high voltage DC signal can then be used by a conventional DC/DC converter which is represented by blocks 105, 106, 107 and 108. Power factor correction (104) is shown in the block diagram of FIG. 1. Many power supplies constructed prior to the year 2000 do not contain a power factor correction element. For older power systems the rectification (102) and storage (103) blocks would have been simply a diode and capacitor. Due to the operating nature of a diode, this meant that power was only drawn from the AC power grid when the voltage of the grid across terminals (101) was higher than the voltage stored in capacitor (103). This means that the grid would see a load profile that is zero for most of the AC cycle, but will then suddenly peak only at the very highest voltage point in the normal AC sine wave. As more switching power supplies are used, this drastic spiking causes problems on the power grid and as a result it has been mandated in many countries that power factor correction be employed in modern AC/DC switching power supplies to ensure that load current is spread out across the entire AC waveform in a way that ensure smooth power consumption from the grid. The power factor correction element (104) is linked to several other blocks and while it has many advantages for the grid power system, it does reduce the overall efficiency of the switching power supply (100). It also adds weight, cost and increases the potential for failure. The remaining blocks in the system are a chopper (105) which takes the high voltage DC signal and chops it into a high-frequency signal which is then applied to a transformer (106) or inductor. The high frequency ensures a small magnetic element can be used. In general, the higher the frequency, the smaller the magnetic element can be. The signal propagates through the transformer (106) to another rectifier (107) and storage element (108) which is at the desired DC potential. Control circuits, which are not shown, monitor the desired parameters at the output (109) and can modify the frequency, pulse width, or other parameters of the switching power system to achieve the desired output (voltage, current or another parameter) to be regulated. Most power systems seek to regulate the voltage at the output (109). It is possible to replace the switching power supply of FIG. 1 with a simple transformer based system that includes only the transformer (106), rectifier (107) and storage (108) elements. However, this would mean that the lower frequency AC grid voltage would be applied to the transformer. This results in a much larger transformer, higher cost and lower efficiency than a switching power supply system. Such a system may also suffer from significant power factor issues and therefore not be offered for sale in some countries.

One embodiment of the system of the invention is illustrated in FIG. 2. The improved switching power supply system (200) eliminates many of the steps required to produce a regulated output. The chopper element (205) operates directly on the input signal (201) converting it to a high frequency alternating current (AC) signal. The waveform is typically a square wave, but it can take other shapes. A major advantage of this first element is the ability for any waveform to be chopped up. The signal could be AC, DC, inverted DC or any arbitrary wave shape. Once the signal is chopped up, it is applied to a transformer (206) or inverter element. The signal is then recovered in a synchronous rectification and polarity correction element (207). This rectification element (207) is controlled by signals (202) which synchronize it to both the frequency of the chopper (205) and the polarity of the input waveform (201). If the goal of the system is to deliver a DC signal then the rectification element (207) operates to maintain a fixed polarity and the energy output is stored in a storage element (208) such as a capacitor. If the goal of the system is to deliver a AC signal then the rectification element (207) reconstructs an AC signal. A small storage element (208) such as a capacitor is used to remove the high frequency chopper noise from the lower frequency AC output signal. Control circuits, which are not shown in FIG. 2 but would be understood by a skilled person, monitor the desired parameters at the output (209). The control circuits can modify the frequency, pulse width, or other parameters of the switching power system to achieve the desired output (voltage, current or another parameter) to be regulated. Most power systems seek to regulate the voltage at the output (209).

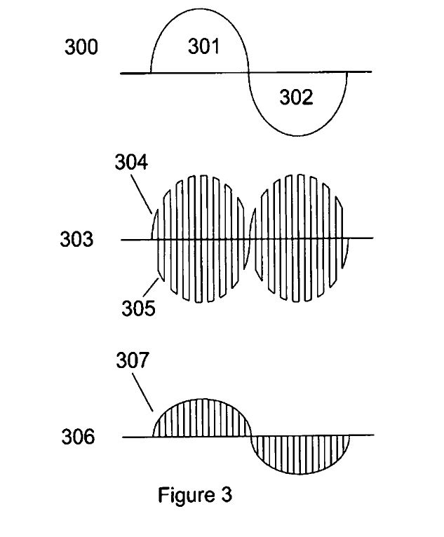

FIG. 3 illustrates the chopping system used on an input signal. In this example an AC sine wave (300) is used. The sine wave has two phases. The positive phase (301) has a voltage which is positive with respect to ground. The second phase (302) has a negative voltage with respect to ground. Once this signal has been chopped up, it will take the form of a much higher frequency chopped wave (303) which is considerably higher in frequency than the input waveform and alternately outputs a positive voltage (304) followed by a negative voltage (305) regardless of the input polarity or phase of the input waveform (300). Power factor correction is not required on this signal because the magnitude of the voltage of the waveform is not altered as it is applied to the transformer. Therefore no power factor distortion is present at this point in the circuit.

Referring back to FIG. 2, a key feature of the rectification block (207) is the ability to maintain current flow out of the transformer and ensure proportional loading throughout the system that is locked to the magnitude of the input waveform to the system. This eliminates the need for power factor correction.

If an AC output is desired from the system then the high-frequency chopped wave (303) would be reassembled after the transformer element to create a signal that has a fundamental frequency equal to the input, but would have a magnitude that depends on the turns-ratio of the transformer element or other switching parameters. This AC output signal (306) would have a high frequency component (307) where the waveform was reassembled which can be removed through appropriate filtering.

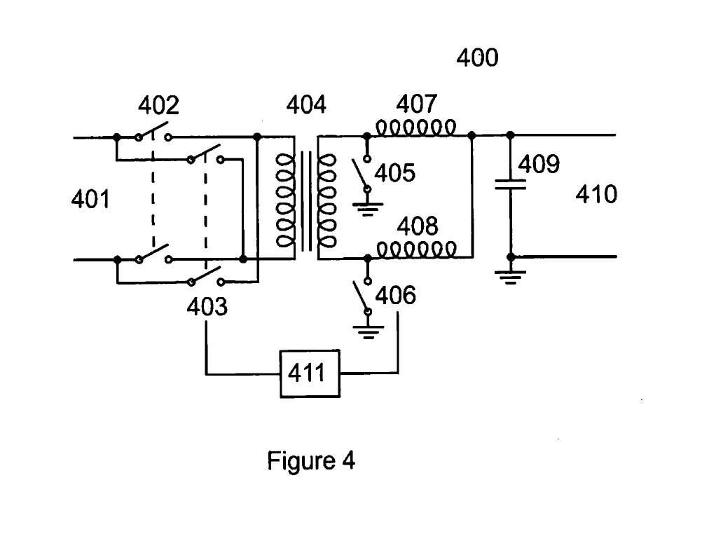

A more detailed description of the circuit to produce DC is provided by reference to FIG. 4. In the circuit (400), the input waveform is applied at the input terminals (401). The input terminals are connected to a gang of interconnected switches that allows the input waveform to be connected to transformer (404) with the connected terminals alternating. When the first switches (402) are closed the top and bottom input terminals are connected to the top and bottom terminals of the transformer (404) respectively. When the second switches (403) are closed, the top and bottom input terminals are connected to the bottom and top (reversed) terminals of the transformer (404). The circuit would be designed to ensure that the switches could not all be on at the same time, but it may be acceptable for the switches to all be off at the same time (as shown). Current flow through an inductive element will tend to continue in the same direction in which it was impressed and will not instantaneously change. We will also make the assumption that the circuit starts ‘at rest’ with all inductors and storage elements in a discharged state and the input waveform in a positive phase.

Referring to FIG. 4, the input switches will close in such a way that current flows from the top of the transformer to the bottom. This will impress a similar current in the secondary winding. The control element (411) will sense the input polarity of the system and will ensure that the positive output grounding switch (405) is closed. This allows current to flow from the ground, through switch (405), down through the transformer (404) secondary winding and out through the positive inductor (408) to the output storage element (409) and on to the output of the system (410). The input switches (402 or 403) will open when an appropriate amount of energy has entered the transformer per the regulator control signals (not shown) generated by the monitoring circuit attached to the output (410) per normal switching power supply control technologies such as pulse width modulation. Input switches will then close such that current flows from the bottom to the top of the transformer (404) primary. This will force a similar reaction in the secondary. The positive output grounding switch (405) will open and the negative grounding switch (406) will close. This provides two paths to the output. The primary path will see current flowing from ground up through the transformer secondary and out through the negative inductor (407) to the output storage element. However, the positive inductor (408) will still have magnetic energy stored from the previous cycle and the direction of current flow from that inductor will also be towards the output. Therefore current will flow up from ground through the switch (406) through the positive inductor (408) and will be combined with the current from negative inductor (407) as it flows to the output. This switching cycle repeats with the only exception that the order in which the input and output switches open and close will be inverted when the input signal waveform polarity or phase is negative.

Referring back to FIG. 3, the order of switching will be different during the positive phase of the waveform (301) compared to the negative phase of the waveform (302). From the above description it is clear that for every switch transition at the input of the circuit, current will flow to the output, such current flow is maintained in both positive and negative polarity switching cycles. As such, this system is ideally suited to situations where power factor loading of the input signal is important, but where the efficiency losses of a power factor correction circuit cannot be tolerated. It can also be appreciated that elimination of the input and output rectification stages of a conventional switching power supply as shown in FIG. 1 would be a benefit to a wide variety of applications. Finally, it can be seen that this system can operate on any waveform and will draw power from any waveform regardless of shape or polarity which makes it an excellent system for improving the quality of power supplied by inconsistent energy sources such as wind, solar, wave motion and a variety of other sustainable energy sources.

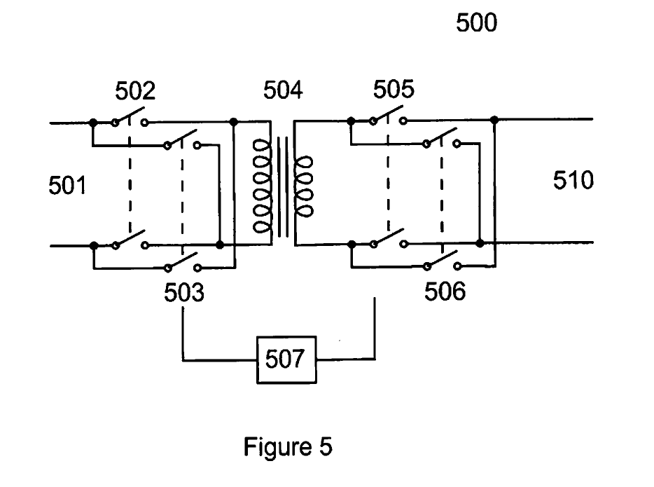

A more detailed description of the circuit to produce AC is provided by reference to FIG. 5. In the circuit (500), the front-end is very similar to the DC circuit shown in the previous figure. The input waveform is applied at the input terminals (501) and is connected to a gang of interconnected switches that allows the input waveform to be connected to a transformer (504) with the connected terminals alternating. When the first switches (502) are closed the top and bottom input terminals are connected to the top and bottom terminals of the transformer (504) respectively. When the second switches (503) are closed, the top and bottom input terminals are connected to the bottom and top (reversed) terminals of the transformer (504). The circuit would be designed to ensure that the switches could not all be on at the same time, but it may be acceptable for the switches to all be off at the same time (as shown). The transformer (504) in this case may have an unequal number of windings. By providing a transformer with more primary windings than secondary windings, the output voltage of the system will be less than the input voltage and the output will track the input roughly proportionally to the turns-ratio of the transformer. The signal from the transformer secondary is then applied to a similar gang of switches (505 and 506) which are used to alter the polarity of the signal such that the high frequency waveform can be removed from the original low frequency waveform. If required a capacitive or filter element could be added at the output terminals (510), but it may not be necessary for all applications. The AC to AC conversion system as shown will be much lighter than a system which uses only a transformer with no switching elements. As a transformer operates with an AC input, the core material is constantly being magnetized and demagnetized by the magnetic field generated by the primary winding. If the input frequency is too low, the core material may become saturated with magnetic flux resulting in a sharp increase in the current flowing through the first winding and overheating of the transformer. This condition can often result in device failure. At a given input frequency, therefore, the core material must have a sufficient magnetic flux capacity to prevent saturation. Because the magnetic flux capacity is dependent upon the geometry of the core structure, the core structure of a transformer at a given frequency and power level has a minimum size. As a result, at relatively low frequencies, transformers tend to be extremely bulky and heavy. By dramatically increasing the effective operating frequency of the transformer we can therefore dramatically reduce the overall weight and size of the system. The circuits illustrated may be implemented using any suitable transformer or inductor configuration which may include separate windings and switch elements. Such circuitry can be expanded to multiple phases and reconfigured into other switching topology implementations as is well understood in the art.

While one or more embodiments of the present invention have been illustrated in detail, the skilled artisan will appreciate that modifications and adaptations to those embodiments may be made without departing from the scope of the present invention as set forth in the following claims.

1. A system for converting an electrical signal from a first form to a second form, said system comprising: a circuit for carrying an input signal having a first polarity and a second polarity and in said first form at a first frequency and a first voltage; a chopper element disposed within said circuit for receiving said input signal and generating a second signal at a second frequency and a second voltage, wherein said second frequency is greater than said first frequency; a transformer element disposed within the circuit and connected to said chopper element, said transformer element including a primary winding and a secondary winding, the transformer element receiving the second signal at said primary winding and generating a third signal at said secondary winding, wherein said third signal has a third voltage and a third frequency equal to said second frequency; a rectification element disposed within the circuit and connected to the transformer element for receiving the third signal from the secondary winding and converting it into a signal in said second form; a control element connected to said rectification element for controlling the rectification element so that said rectified signal is a direct current signal at a desired magnitude; and, a storage element disposed within the circuit and connected to the rectification element for receiving said direct current signal from the rectification element and storing the direct current signal.

2. The system of claim 1 wherein the input signal is an alternating current signal.

3. The system of claim 1 wherein the input signal is direct current of any polarity

4. The system of claim 1 wherein the chopper element includes means for alternately inverting the polarity of the input signal.

5. The system of claim 1 wherein the rectification element is a synchronous rectification and polarity correction element.

6. The system of claim 5 wherein the control element is connected between the chopping element and the rectification element so that the rectified signal is synchronized to said first frequency and with the desired polarity.

7. The system of claim 1 wherein the second frequency is greater than 100 times the first frequency.

8. The system of claim 1 wherein the chopper element comprises a first set of input switches that close to direct the second signal from the top of the primary winding to the bottom of the primary winding so that the third signal is induced in the secondary winding from the top of the secondary winding to the bottom of the secondary winding the result being that the second signal and the third signal have the same direction.

9. The system of claim 8 wherein the chopper element further comprises a second set of input switches that close to direct the second signal from the bottom of the primary winding to the top of the primary winding so that third signal is induced in the second winding from the bottom of the secondary winding to the top of the secondary winding the result being that the second and the third signal have the same direction.

10. The system of claim 9 wherein said first set of input switches and second set of input switches are never closed at the same time.

11. The system of claim 10 wherein the first set and second set of switches open and close in an alternating fashion at a frequency equal to the second frequency.

12. The system of claim 10 wherein the first set and second set of switches open and close in an alternating fashion at a frequency equal to the second frequency.

13. The method of claim 12 wherein the transformer has multiple primary and secondary windings to allow multi-phase operation.

14. The method of claim 13 wherein the transformer may have multiple secondary windings to allow multiple output signals to be generated.

15. In a circuit carrying a first signal of any arbitrary polarity, a first form, a first frequency and a first voltage, a method for converting said first signal from said first form to a second form, said method comprising the following steps: placing a chopper element within said circuit for receiving the first signal, wherein said chopper element generates a second signal output at a second frequency and a second voltage, wherein said second frequency is greater than said first frequency; placing a transformer element within the circuit, said transformer element having a primary winding and a secondary winding so that said second signal output is received by said primary winding thereby inducing a third signal output in said secondary winding wherein said third signal output has a third voltage and a third frequency equal to said second frequency; placing a reconstruction element within the circuit so that the third signal output is received by said reconstruction element for conversion to said second form; and, placing a control element between the chopper element and the rectification element for controlling the rectification element so that said reconstructed signal is at the desired magnitude and polarity with a frequency equal to the first frequency.
